(19) United States
(12) Patent Application Publication
(10) Pub. No.: US 2016/0050671 A1
(43) Pub. Date: Feb. 18, 2016

(54) CENTRAL CONTROLLER AND RESOURCE ALLOCATION METHOD THEREOF FOR USE IN A CELLULAR NETWORK

(71) Applicant: Institute For Information Industry, Taipei (TW)

(72) Inventors: Ya-Ju YU, Kaohsiung City (TW); Wen-Hsin WEI, Taipei City (TW); Chun-Teh LEU, Taipei City (TW); Li WAN, Taipei City (TW)

(21) Appl. No.: 14/502,098

(22) Filed: Sep. 30, 2014

(30) Foreign Application Priority Data
Aug. 18, 2014 (TW) 103128222

(51) Int. Cl. H04W 72/04

(52) U.S. Cl. CPC H04W 72/0493

(57) ABSTRACT

A central controller and a resource allocation method thereof for use in a cellular network are provided. The cellular network includes a user equipment and the central controller. The central controller includes a transceiver and a processor. The transceiver receives a service request signal from the user equipment. The processor is electrically connected to the transceiver and is used to determine a requested service classification of the user equipment according to the service request signal, select a selected resource allocation strategy from a resource allocation strategy set according to the requested service classification, and allocate resources to the user equipment according to the selected resource allocation strategy. The central controller and the user equipment transmit data by the resource.

### PRIORITY

This application claims priority to Taiwan Patent Application No. 103128222 filed on Aug. 18, 2014, which is incorporated by reference herein in its entirety.

### FIELD

The present invention relates to a central controller and a resource allocation method thereof for use in a cellular network. More particularly, the central controller of the present invention selects the most appropriate resource allocation strategy from a number of resource allocation strategies according to information about the requested service classification/attributes provided by a user equipment (UE).

### BACKGROUND

With the widespread use of cellular networks, a lot of central controllers and UEs that communicate via the cellular networks are often confronted with the resource allocation problem. However, the prior art solutions usually adopt a single resource allocation strategy to serve the diversified UEs because it has not been recognized in the prior art that performances of different resource allocation strategies are mutually exclusive.

For example, adopting a throughput optimization allocation strategy will lead to high power consumption of the central controller and a UE, and adopting a UE energy-saving allocation strategy will lead to higher power consumption of the central controller and reduces the capacity available. Therefore, if the central controller adopts a single resource allocation strategy to serve UEs that require diversified services, it would be impossible to make an optimized tradeoff between different respects of the system performances.

Accordingly, an urgent need exists in the art to provide a central controller capable of providing diversified resource allocation strategies so that the most appropriate resource allocation strategy can be selected for each of the UEs that require diversified services respectively and an optimized tradeoff between different system performances of the cellular network can be achieved.

### SUMMARY

The present invention includes a central controller and a resource allocation method thereof for use in a cellular network, which can select a resource allocation strategy according to the classification of a service requested by the UE so as to achieve the purpose of dynamically selecting the resource allocation strategies.

To achieve the aforesaid objective, the present invention includes a central controller for use in a cellular network. The cellular network comprises a first UE and the central controller, and the central controller comprises a transceiver and a processor. The transceiver is configured to receive a service request signal from the first UE. The processor is electrically connected to the transceiver, and is configured to execute a resource allocation procedure which comprises the following steps of: determining a requested service classification of the first UE according to the service request signal by the processor; selecting a selected resource allocation strategy from a resource allocation strategy set according to the requested service classification by the processor; and allocating resources to the first UE according to the selected resource allocation strategy by the processor so that the central controller and the first UE transmit data corresponding to the service request signal via the resources.

To achieve the aforesaid objective, the present invention includes a resource allocation method for a central controller in a cellular network. The cellular network comprises a first UE and the central controller. The resource allocation method comprises the following steps of: enabling the central controller to receive a service request signal from the first UE; enabling the central controller to determine a requested service classification of the first UE according to the service request signal; enabling the central controller to select a selected resource allocation strategy from a resource allocation strategy set according to the requested service classification; and enabling the central controller to allocate resources to the first UE according to the selected resource allocation strategy so that the central controller and the first UE transmit data corresponding to the service request signal via the resources.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram of a cellular network according to a first embodiment and a second embodiment of the present invention;

FIG. 2 is a block diagram of a cellular network according to a third embodiment of the present invention;

FIG. 3 is a flowchart diagram of a resource allocation method according to a fourth embodiment of the present invention;

FIG. 4 is a flowchart diagram of a resource allocation method according to a fifth embodiment of the present invention;

FIG. 5 is a flowchart diagram of a resource allocation method according to a sixth embodiment of the present invention;

FIG. 6 is a flowchart diagram of a resource allocation method according to a seventh embodiment of the present invention; and

FIG. 7 is a flowchart diagram of a resource allocation method according to an eighth embodiment of the present invention.

### DETAILED DESCRIPTION

Hereinbelow, the present invention will be explained with reference to example embodiments thereof. It should be appreciated that, the example embodiments are not intended to limit the present invention to any specific examples, embodiments, environment, applications or particular implementations as described in these example embodiments. Therefore, description of these example embodiments is only for purpose of illustration rather than to limit the present invention, and the scope of this application shall be governed by the claims.

In addition, in the following embodiments and the attached drawings, elements not directly related to the present invention are omitted from depiction; and dimensional relationships among individual elements in the following drawings are illustrated only for ease of understanding but not to limit the actual scale.

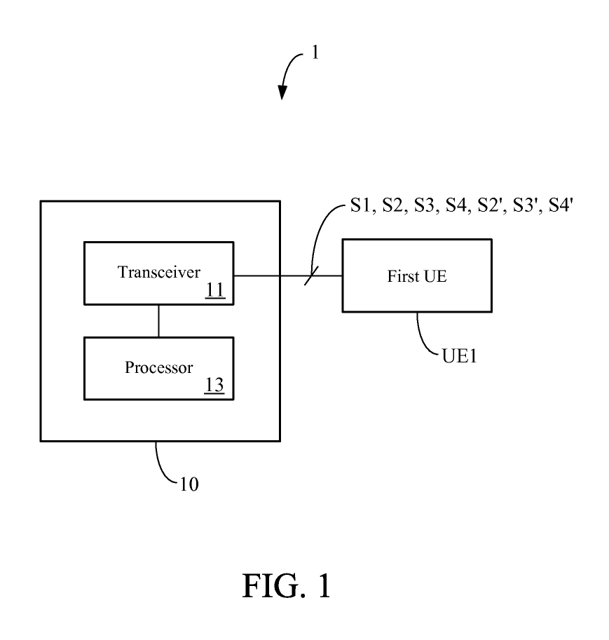

A first embodiment of the present invention is as shown in FIG. 1, which depicts a block diagram of a cellular network 1. The cellular network 1 is, for example, a network conforming to the architecture of Long Term Evolution (LTE), a Worldwide Interoperability for Microwave Access (WiMAX) network, or a Cloud of Radio Access Network (Cloud-RAN), but is not limited thereto; and any cellular network shall be covered within the scope of the present invention.

The cellular network 1 comprises a central controller 10 and a first UE UE1. For example, in the LTE network architecture, the central controller 10 is an Evolved Node B (eNB); in the WiMAX network architecture, the central controller 10 is a base station; and in the Cloud-RAN architecture, the central controller 10 is a base band unit (BBU) which is configured to allocate network resources. The first UE UE1 is a client which requests an application service from the central controller 10.

The central controller 10 comprises a transceiver 11 and a processor 13 electrically connected to the transceiver 11. The transceiver 11 is configured to receive a service request signal S1 from the first UE UE1, and the processor 13 executes a resource allocation procedure according to the service request signal S1.

The requested service classification may usually be classified into a periodic data transmission classification and a non-periodic data transmission classification. In the LTE architecture, the periodic data transmission classification is, for example, a Guaranteed Bit Rate (GBR) classification or a Constant Bit Rate (CBR) classification. The service using the GBR or the CBR (e.g., a service requested by the service request signal S1) is a Voice over Internet Protocol (VoIP) service, a video call service, a video streaming service, an on-line gaming service or the like.

The non-periodic data transmission classification is, for example, a Non-Guaranteed Bit Rate (Non-GBR) classification or a Non-Constant Bit Rate (Non-CBR) classification. The service using the Non-GBR or the Non-CBR (e.g., a service requested by the service request signal S1) is a web browsing service, an E-mail service, a chat service, a social application service, a transmission service using the file transfer protocol (FTP), or the like.

It should be appreciated that, before executing the resource allocation procedure, the processor 13 must firstly determine whether the service request signal S1 belongs to a downlink application service request or an uplink application service request. The resource allocation procedure executed by the processor 13 varies depending on whether the service request signal S1 is the uplink application service request or the downlink application service request.

Further speaking, depending on whether the service request signal S1 is the uplink application service request or the downlink application service request, the central controller 10 will select the resource allocation strategy in different ways. In case of the downlink application service request, energy-saving of both the central controller 10 and the first UE UE1 need to be considered; and in case of the uplink application service request, the energy-saving of only the first UE UE1 needs to be considered while energy-saving of the central controller 10 needs not be considered.

It should be firstly appreciated that, in case that the service request signal S1 belongs to the “downlink application service request”, the resource allocation procedure begins with a step of determining a requested service classification of the first UE UE1 by the processor 13 according to the service request signal S1. The determination is made as follows. For example, in the LTE architecture, the central controller 10 can know a Qos class identity (QCI) from a radio resource control (RRC) signal according to the service request signal S1, and then know from the QCI the requested service classification corresponding to the service request signal S1. In the WiMAX architecture, the central controller 10 can know a Quality of Service (QoS) classification from a Service-specific Convergence Sublayer (CS) signal under the Media Access Control (MAC) according to the service request signal S1, and then know from the QoS classification the requested service classification corresponding to the service request signal S1. Because how to know the QCI is well known to those skilled in the art, this will not be further described herein.

After having determined the requested service classification of the service request signal S1, the processor 13 continues to execute the resource allocation procedure by selecting a selected resource allocation strategy from a resource allocation strategy set according to the requested service classification.

In case of the downlink application service request, the resource allocation strategy set comprises a UE energy-saving allocation strategy, a central controller energy-saving allocation strategy and a throughput optimization allocation strategy. However, the present invention is not limited thereto. The resource allocation strategy set may also comprise other resource allocation strategies or may be replaced by other resource allocation strategies.

When it is determined that the requested service classification is the “non-periodic data transmission classification”, the processor 13 will select the throughput optimization allocation strategy as the selected resource allocation strategy. When it is determined that the requested service classification is the “periodic data transmission classification”, the processor 13 will directly select the UE energy-saving allocation strategy as the selected resource allocation strategy; or, the processor 13 may further determine whether the first UE UE1 further requests an additional service belonging to the non-periodic data transmission classification from the central controller 10. If the determination result is “yes”, the processor 13 selects the central controller energy-saving allocation strategy as the selected resource allocation strategy because other non-periodic data transmissions might severely affect the performance of the UE downlink energy-saving allocation strategy; and if the determination result is “no”, the processor 13 selects the UE energy-saving allocation strategy as the selected resource allocation strategy.

In case that the service request signal S1 belongs to the “uplink application service request”, the energy-saving allocation strategy of the central controller 10 is not considered. Therefore, as compared to the case where the service request signal S1 belongs to the “downlink application service request”, the content of the resource allocation strategy set and the determination content of the resource allocation procedure are different.

In the case where the service request signal S1 belongs to the “uplink application service request”, the resource allocation strategy set only comprises the UE energy-saving allocation strategy and the throughput optimization allocation strategy. Therefore, if the requested service classification is the non-periodic data transmission classification, the processor 13 selects the throughput optimization allocation strategy as the selected resource allocation strategy; and if the requested service classification is the periodic data transmission classification, the processor 13 selects the UE energy-saving allocation strategy as the selected resource allocation strategy.

Then, the processor 13 continues to execute the resource allocation procedure by allocating resources to the first UE UE1 according to the aforesaid selected resource allocation strategy. It should be appreciated that, the content of this step remains the same no matter whether the service request signal S1 is the downlink or the uplink application service request. Afterwards, the central controller 10 and the first UE UE1 transmit data corresponding to the service request signal via the resources.

Referring still to FIG. 1, a second embodiment of the present invention is shown therein. A cellular network, a central controller and a first UE in this embodiment are the same as the cellular network 1, the central controller 10 and the first UE UE1 in the first embodiment, and the cellular network, the central controller, and the first UE of this embodiment can also execute all procedures and functions of the first embodiment. Therefore, the cellular network, the central controller, and the first UE are still designated as the cellular network 1, the central controller 10 and the first UE UE1 as in the first embodiment.

Still considering the case where the service request signal S1 belongs to the “downlink application service request” in the first embodiment, the processor 13 further determines whether the first UE UE1 further requests an additional service belonging to the non-periodic data transmission classification from the central controller 10. If the determination result is “no”, the transceiver 11 may select the resource allocation strategy according to a piece of assistance information S2 received from the first UE UE1. For example, the assistance information S2 is a piece of UE assistance information in Release 12 of the 3GGP standard.

Then, the resource allocation procedure further comprises a step of determining whether the assistance information S2 carries a user equipment energy-saving request S3 by the processor 13. If the determination result is “yes”, the UE energy-saving allocation strategy is selected as the selected resource allocation strategy.

If the processor 13 determines that the assistance information S2 does not comprise the UE energy-saving request S3, then the resource allocation procedure further comprises a step of determining whether the first UE UE1 supports a system discontinuous reception (DRX) mechanism by the processor 13. If the determination result is no, the processor 13 selects the central controller energy-saving allocation strategy as the selected resource allocation strategy according to the fact that the requested service classification belongs to the periodic data transmission classification and the result that the first UE UE1 does not support the system DRX mechanism. Further speaking, if the first UE UE1 supports the system DRX mechanism, then the first UE UE1 will transmit an RRC signal carrying a piece of related information to the central controller 10. Upon receiving the RRC signal, the central controller 10 can know whether the first UE UE1 supports the system DRX mechanism.

If the processor 13 determines that the first UE UE1 supports the system DRX mechanism, the processor 13 will directly select the UE energy-saving allocation strategy as the selected resource allocation strategy according to the fact that the requested service classification belonging to the periodic data transmission classification and the result that the first UE UE1 supports the system DRX mechanism; or, the resource allocation procedure further comprises a step of determining whether the assistance information S2 carries a piece of UE power level information S4 of the first UE UE1 by the processor 13.

If the assistance information S2 carries the UE power level information S4 therein, then the resource allocation procedure further comprises a step of determining whether a UE power level in the UE power level information is higher than a threshold or is in a charging state. If the determination result is “yes”, the processor 13 selects the central controller energy-saving allocation strategy from the resource allocation strategy set as the selected resource allocation strategy according to the fact that the requested service classification belongs to the periodic data transmission classification and the result that the UE power level is higher than the threshold; and if the determination result is “no”, the processor 13 selects the UE energy-saving allocation strategy from the resource allocation strategy set as the selected resource allocation strategy according to the fact that the requested service classification belongs to the periodic data transmission classification and the result that the UE power level is lower than the threshold.

It should be appreciated that, at least one of the aforesaid procedures “determining whether the assistance information S2 carries a UE energy-saving request S3 by the processor 13”, “determining whether the first UE UE1 supports the system DRX mechanism by the processor 13” and “determining whether a UE power level in the UE power level information is higher than a threshold or is in a charging state by the processor 13 if the assistance information S2 carries the UE power level information S4 therein” may be selected to be executed in the resource allocation procedure, and because how this operates is well known to those skilled in the art, this will not be further described herein.

In the case where the service request signal S1 belongs to the “uplink application service request”, the processor 13 does not determine whether the first UE UE1 further requests an additional service belonging to the non-periodic data transmission classification from the central controller 10 because the UE uplink energy-saving resource allocation strategy will not be affected by other non-periodic data transmissions. Instead, if the requested service classification is the periodic data transmission classification in the step of “selecting the selected resource allocation strategy from the resource allocation strategy set according to the requested service classification by the processor 13”, then in addition to the resource allocation procedure described in the first embodiment, the resource allocation procedure further comprises a step of determining whether a piece of assistance information S2′ received by the transceiver 11 from the first UE UE1 carries a UE energy-saving request S3′ by the processor 13. If the determination result is “yes”, the processor 13 selects the UE energy-saving allocation strategy as the selected resource allocation strategy according to the fact the requested service classification belongs to the periodic data transmission classification and the UE energy-saving request S3′.

If the determination result is “no”, the processor 13 selects the throughput optimization allocation strategy as the selected resource allocation strategy; or, if the assistance information S2′ further carries a piece of UE power level information S4′ of the first UE UE1, the resource allocation procedure further comprises, after the processor 13 determines that the assistance information S2′ does not comprise the UE energy-saving request S3′, a step of determining whether a UE power level in the UE power level information S4′ is higher than a threshold or whether the first UE UE1 is in a charging state by the processor 13. If the determination result is “yes”, the throughput optimization allocation strategy is selected as the selected resource allocation strategy; and if the determination result is “no”, the UE energy-saving allocation strategy is selected as the selected resource allocation strategy.

It should be appreciated that, at least one of the aforesaid procedures “determining whether the assistance information S2′ carries a UE energy-saving request S3′ by the processor 13”, and “determining whether a UE power level in the UE power level information S4′ is higher than a threshold or is in a charging state by the processor 13 if the assistance information S2 carries the UE power level information S4′ therein” may be selected to be executed in the resource allocation procedure, and because how this operates is well known to those skilled in the art, this will not be further described herein.

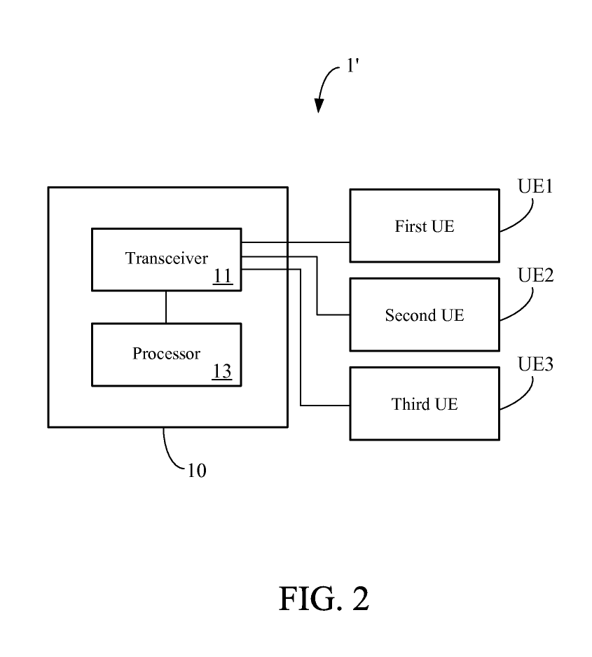

A third embodiment of the present invention is shown in FIG. 2, which depicts a block diagram of a cellular network. This embodiment mainly describes how to plan as a whole and to execute the resource allocation when the central controller 10 is to execute a plurality of kinds of resource allocation strategies for a plurality of UEs.

It should be appreciated that, a central controller and a first UE in this embodiment are the same as the central controller 10 and the first UE UE1 in the first embodiment and the second embodiment, and the central controller and the first UE of this embodiment can also execute all procedures and functions in the first embodiment and the second embodiment. Therefore, the central controller and the first UE of this embodiment are still designated as the central controller 10 and the first UE UE1 as in the first embodiment and the second embodiment.

As compared to the cellular network 1 in the first embodiment and the second embodiment, a cellular network 1′ in this embodiment further comprises a second UE UE2 and a third UE UE3 as shown in FIG. 2. Of course, because the number of the UEs comprised in the cellular network 1′ is not limited to what is illustrated in the present invention, any number ranging from 1 to an upper limit is possible.

In the case where the service request signal S1 belongs to the “downlink application service request”, assume that the processor 13 selects the UE energy-saving allocation strategy as the selected resource allocation strategy for the first UE UE1, selects the throughput optimization allocation strategy as the selected resource allocation strategy for the second UE UE2, and selects the central controller energy-saving allocation strategy as the selected resource allocation strategy for the third UE UE3.

Then, the resource allocation procedure further comprises, before the step of “allocating resources to the first UE according to the selected resource allocation strategy by the processor 13”, the following step of: determining whether an expected total amount of resources used by the first UE UE1, the second UE UE2 and the third UE UE3 is larger than a congestion critical value by the processor 13. If the determination result is “yes”, saving energies for the UE would consume more resources. Therefore, the processor 13 updates the UE energy-saving allocation strategy selected for the first UE UE1 into the central controller energy-saving allocation strategy.

The processor 13 allocates resources to the first UE UE1, the second UE UE2 and the third UE UE3 according to a first execution sequence. In detail, the first execution sequence may be as follows: the UE energy-saving allocation strategy has the highest priority, the central controller energy-saving allocation strategy has the second highest priority, and the throughput optimization allocation strategy has the lowest priority. Generally speaking, the periodic data transmission has a higher priority than the non-periodic data transmission, and the UE energy-saving allocation strategy is more important than and, thus, shall be executed with a higher priority than the central controller energy-saving allocation strategy and the throughput optimization allocation strategy. However, in a case where the expected total amount of resources used is larger than the congestion critical value, the UE energy-saving allocation strategy is no longer executed. Therefore, the processor 13 will firstly allocate resources to UEs for which the central controller energy-saving allocation strategy is selected as the selected resource allocation strategy. That is, the processor 13 will firstly allocate resources to the first UE UE1 and the third UE UE3, and then allocate resources to the second UE UE2.

In a case where the expected total amount of resources used is no larger than the congestion critical value, the processor 13 continues to select the UE energy-saving allocation strategy as the selected resource allocation strategy for the first UE UE1. Therefore, the processor 13 will, according to the first execution sequence, allocate resources firstly to the first UE UE1, secondly to the third UE UE3, and finally to the second UE UE2. It should be appreciated that, the content of the aforesaid first execution sequence is only for purpose of illustration rather than to limit the present invention, and the aforesaid first execution sequence may also be adjusted depending on the actual need.

Next, how the central controller 10 plans as a whole and executes the resource allocation in the case where the service request signal S1 belongs to the “uplink application service request” will be described. Because the uplink application service request does not consider energy-saving of the central controller, the resource allocation strategy set only comprises the UE energy-saving allocation strategy and the throughput optimization allocation strategy in this case.

Assume that the processor 13 selects the UE energy-saving allocation strategy as the selected resource allocation strategy for the first UE UE1, selects the throughput optimization allocation strategy as the selected resource allocation strategy for the second UE UE2, and selects the UE energy-saving allocation strategy as the selected resource allocation strategy for the third UE UE3.

In case of an uplink application service request, the processor 13 directly provides a second execution sequence without determining whether an expected total amount of resources used by the first UE UE1˜the third UE UE3 is larger than a congestion critical value. Generally speaking, the UE energy-saving allocation strategy should be executed with a priority over the throughput optimization allocation strategy because it is more important. Therefore, the second execution sequence is as follows: the UE energy-saving allocation strategy is executed firstly with a priority, and the throughput optimization allocation strategy is executed secondly.

The processor 13 will, according to the aforesaid second execution sequence, allocate resources firstly to the first UE UE1 and the third UE UE3, and then to the second UE UE2. It should be appreciated that, the content of the aforesaid second execution sequence is only for purpose of illustration rather than to limit the present invention, and the aforesaid second execution sequence may also be adjusted depending on the actual need.

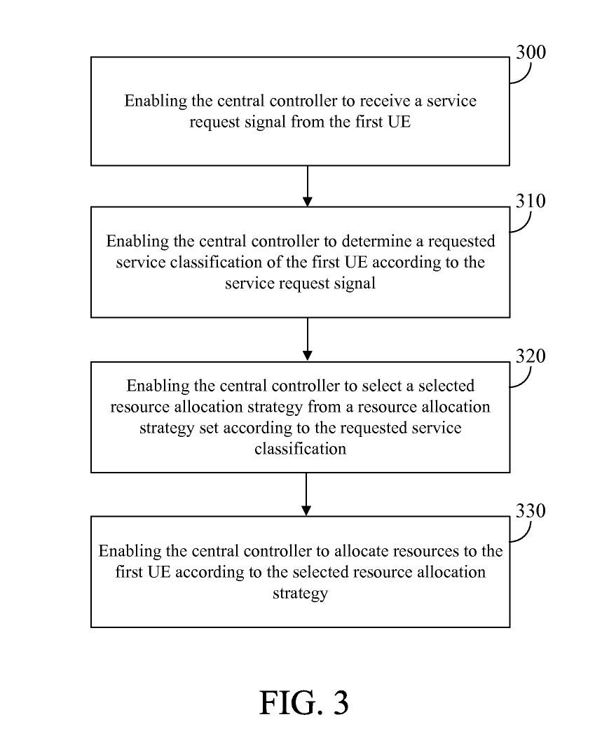

A fourth embodiment of the present invention is shown in FIG. 3, which depicts a resource allocation method of the present invention. The resource allocation method is used in a central controller in a cellular network. The cellular network comprises the central controller and a first UE. It should be appreciated that, the cellular network, the central controller and the first UE set forth in this embodiment have the same functions as the cellular network 1, the central controller 10 and the first UE UE1 of the first embodiment.

Firstly in the resource allocation method, a step 300 is executed to enable the central controller to receive a service request signal from the first UE. The service request signal is a downlink application service request or an uplink application service request. Next, a step 310 is executed to enable the central controller to determine a requested service classification of the first UE according to the service request signal. The requested service classification is classified into a periodic data transmission classification and a non-periodic data transmission classification, but is not merely limited thereto. Other appropriate classifications may also be used as the requested service classifications in the present invention.

Afterwards, a step 320 is executed to enable the central controller to select a selected resource allocation strategy from the resource allocation strategy set according to the requested service classification. Specifically, if the service request signal is a downlink application service request, the resource allocation strategy set will comprise a UE energy-saving allocation strategy, a central controller energy-saving allocation strategy and a throughput optimization allocation strategy; and if the service request signal is an uplink application service request, the resource allocation strategy set may be classified into a UE energy-saving allocation strategy and a throughput optimization allocation strategy because the energy-saving of the central controller is not considered.

Then, a step 330 is executed to enable the central controller to allocate resources to the first UE according to the selected resource allocation strategy so that the central controller and the first UE transmit data corresponding to the service request signal via the resources.

In addition to the aforesaid steps, the resource allocation method of the fourth embodiment can also execute all the operations and functions of the central controller of the first embodiment. Because how the resource allocation method of the fourth embodiment executes these operations and functions can be readily known by those of ordinary skill in the art based on the aforesaid first embodiment, it will not be further described herein.

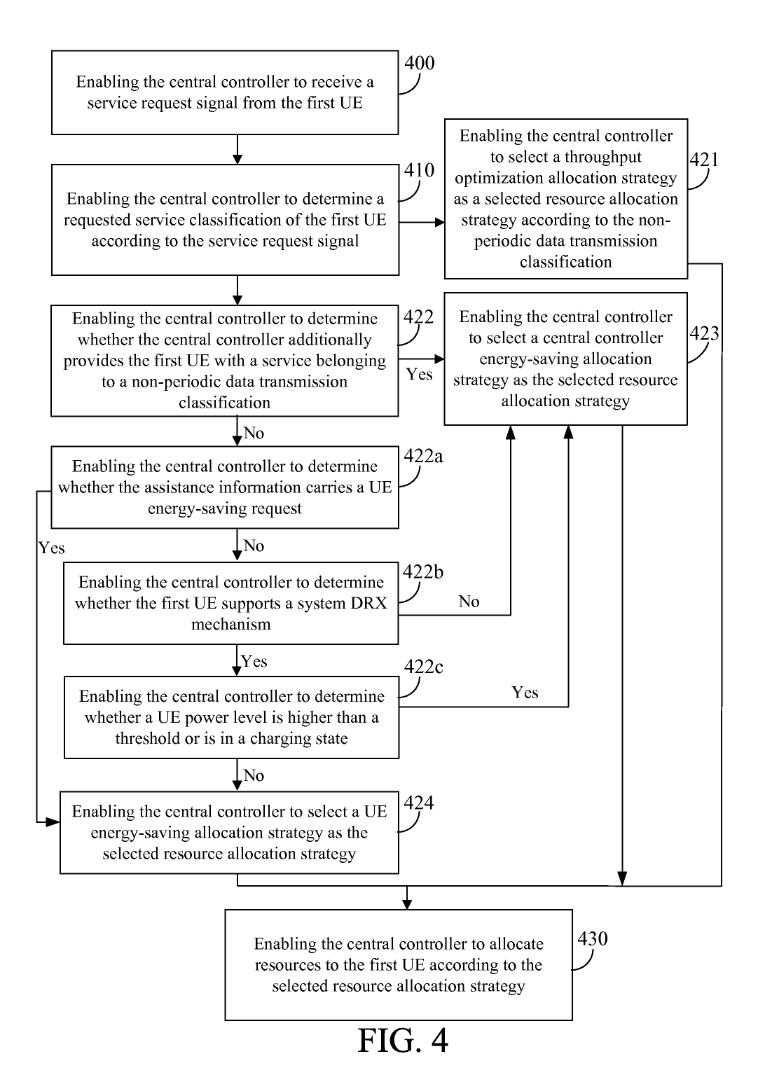

A fifth embodiment of the present invention is shown in FIG. 4, which depicts a resource allocation method of the present invention in case of a downlink application service request. The resource allocation method is used in a central controller in a cellular network. The cellular network comprises the central controller and a first UE. It should be appreciated that, the cellular network, the central controller and the first UE set forth in this embodiment have the same functions as the cellular network 1, the central controller 10 and the first UE UE1 of the first embodiment and the second embodiment.

Firstly in the resource allocation method, a step 400 is executed to enable the central controller to receive a service request signal from the first UE. The service request signal is a downlink application service request, and a resource allocation strategy set of this embodiment comprises a UE energy-saving allocation strategy, a central controller energy-saving allocation strategy and a throughput optimization allocation strategy. Next, a step 410 is executed to enable the central controller to determine a requested service classification of the first UE according to the service request signal. Specifically in this embodiment, the central controller determines the requested service classification of the first UE according to the service request signal belonging to the downlink application service request. If the requested service classification is a non-periodic data transmission classification, a step 421 is executed to enable the central controller to select the throughput optimization allocation strategy as a selected resource allocation strategy according to the non-periodic data transmission classification.

If the requested service classification is a periodic data transmission classification, a step 422 is executed to enable the central controller to further determine whether the central controller additionally provides the first UE with a service belonging to a non-periodic data transmission classification. If the determination result is “yes”, a step 423 is executed to enable the central controller to select the central controller energy-saving allocation strategy as the selected resource allocation strategy; and if the determination result is “no”, a step 424 is executed to enable the central controller to select the UE energy-saving allocation strategy as the selected resource allocation strategy.

Next, after the step 422, 423, or 424, a step 430 is further executed to enable the central controller to allocate resources to the first UE according to the selected resource allocation strategy so that the central controller and the first UE transmit data corresponding to the service request signal via the resources.

It should be appreciated that, in addition to the steps 410, 421, 422, 423, 424 and 430, the resource allocation method of this embodiment may optionally comprise steps 422a, 422b and 422c for making further determinations. Further speaking, the step 400 of the resource allocation method further comprises the following step of: enabling the central controller to receive an assistance information (e.g., a piece of UE assistance information in Release 12 of the 3GGP standard) (not depicted) from the first UE. The steps 422a, 422b and 422c are executed between the step 422 and the step 424, and will be described respectively as follows.

As shown in FIG. 4, the step 422a is further executed after the step 422 to enable the central controller to determine whether the assistance information S2 carries a UE energy-saving request therein. If the determination result is “yes”, the step 424 is executed. If the determination result is “no”, the step 422b is further executed to enable the central controller to determine whether the first UE supports a system DRX mechanism; and if the determination result is “no”, the step 423 is executed. Further speaking, if the first UE UE1 supports the system DRX mechanism, then the first UE UE1 will transmit an RRC signal carrying a piece of related information to the central controller 10. Upon receiving the RRC signal, the central controller 10 can know whether the first UE UE1 supports the system DRX mechanism.

If the determination result is yes, the step 430 may be directly executed, or the step 422c may be further executed to enable the central controller to determine whether a UE power level in a piece of UE power level information of the first UE carried in the assistance information is higher than a threshold or is in a charging state. If the determination result is “yes”, it means that there is no need to save energy for the first UE and thus the method proceeds to the step 423. If the determination result is “no”, the step 424 is executed. It should be appreciated that, one or two or all of the steps 422a, 422b and 422c may be executed, or the steps 422a, 422b and 422c may all be omitted; and because how this operates is well known to those skilled in the art, this will not be further described herein.

In addition to the aforesaid steps, the resource allocation method of the fifth embodiment can also execute all the operations and functions of the central controller in case of the downlink application service request in the first embodiment and the second embodiment. Because how the resource allocation method of the fifth embodiment executes these operations and functions can be readily known by those of ordinary skill in the art based on the aforesaid first embodiment and second embodiment, it will not be further described herein.

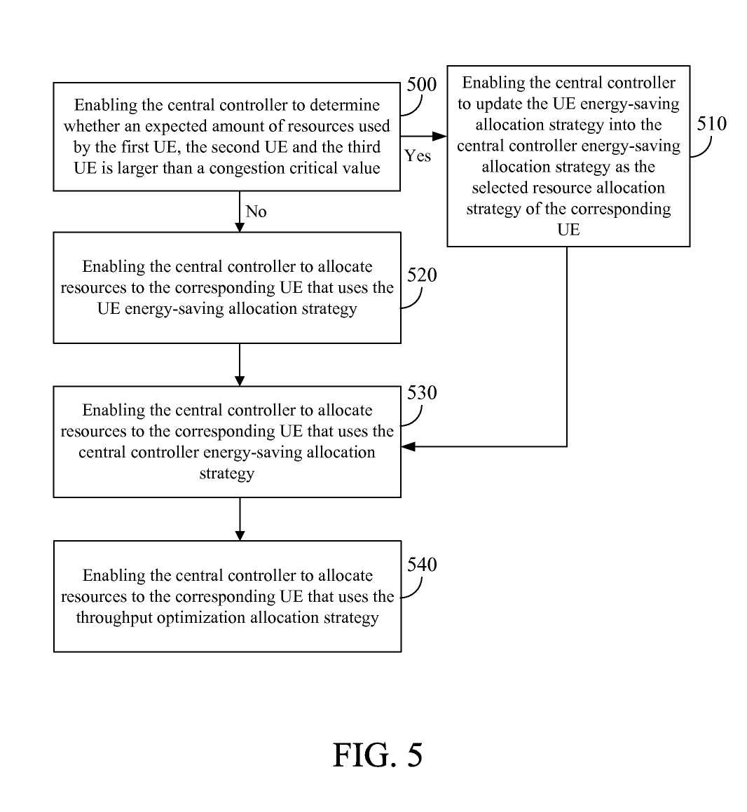

A sixth embodiment of the present invention is shown in FIG. 5, which depicts a resource allocation method of the present invention in case of a downlink application service request. The resource allocation method and elements involved (i.e., a cellular network, a central controller and a first UE) of the present invention are the same as the resource allocation method and the involved elements in the fifth embodiment except that the cellular network of this embodiment further comprises a second UE and a third UE. It can be known from the plurality of UEs arranged in this embodiment that this embodiment mainly focuses on how to allocate resources to the plurality of UEs that use different resource allocation strategies. It should be appreciated that, the number of the UEs in this embodiment is only provided for purpose of illustration rather than to limit the present invention.

In this embodiment, assume that the central controller executes the steps 400˜424 of the fifth embodiment for the first UE to the third UE respectively, and the central controller selects the UE energy-saving allocation strategy as the selected resource allocation strategy for the first UE, selects the throughput optimization allocation strategy as the selected resource allocation strategy for the second UE, and selects the central controller energy-saving allocation strategy as the selected resource allocation strategy for the third UE.

Herein, the step 430 of the fifth embodiment described in FIG. 4 may be construed as a step for a single UE. However, the central controller usually allocates resources to a plurality of UEs, and in this embodiment, allocates resources to the first UE, the second UE and the third UE according to a first execution sequence. In detail, the first execution sequence may be as follows: the UE energy-saving allocation strategy is executed firstly with the highest priority, the central controller energy-saving allocation strategy is executed with the second highest priority, and the throughput optimization allocation strategy is executed with the lowest priority.

As shown in FIG. 5, a step 500 is further executed in the resource allocation method to enable the central controller to determine whether an expected total amount of resources used by the first UE, the second UE and the third UE is larger than a congestion critical value.

If the determination result is yes, it means that saving energy for the UE will consume more resources, so a step 510 is further executed to enable the central controller to update the UE energy-saving allocation strategy into the central controller energy-saving allocation strategy as the selected resource allocation strategy of the corresponding UE. That is, in this embodiment, the UE energy-saving allocation strategy selected for the first UE will be updated into the central controller energy-saving allocation strategy.

Then, the selected resource allocation strategies of both the first UE and the third UE are the central controller energy-saving allocation strategy. Because the UE energy-saving allocation strategy is no longer used, a step 530 is directly executed to enable the central controller to allocate resources to the corresponding UEs (i.e., the first UE and the third UE) that use the central controller energy-saving allocation strategy. Afterwards, a step 540 in the resource allocation method is directly executed to enable the central controller to allocate resources to the corresponding UE (i.e., the second UE) that uses the throughput optimization allocation strategy.

If the expected total amount of resources used is no larger than the congestion critical value, then the first execution sequence is adopted in the resource allocation method, and steps 520, 530 and 540 are executed to allocate resources.

As can be known from the above descriptions, the first execution sequence is represented by the sequence and the contents of the steps 520, 530 and 540. It should be appreciated that, the content of the first execution sequence is provided only for purpose of illustration rather than to limit the present invention, and the aforesaid first execution sequence may also be adjusted depending on the actual need.

In addition to the aforesaid steps, the resource allocation method of the sixth embodiment can also execute all the operations and functions of the central controller in the case of the downlink application service request in the first embodiment to the third embodiment. Because how the resource allocation method of the sixth embodiment executes these operations and functions can be readily known by those of ordinary skill in the art based on the aforesaid first embodiment to third embodiment, it will not be further described herein.

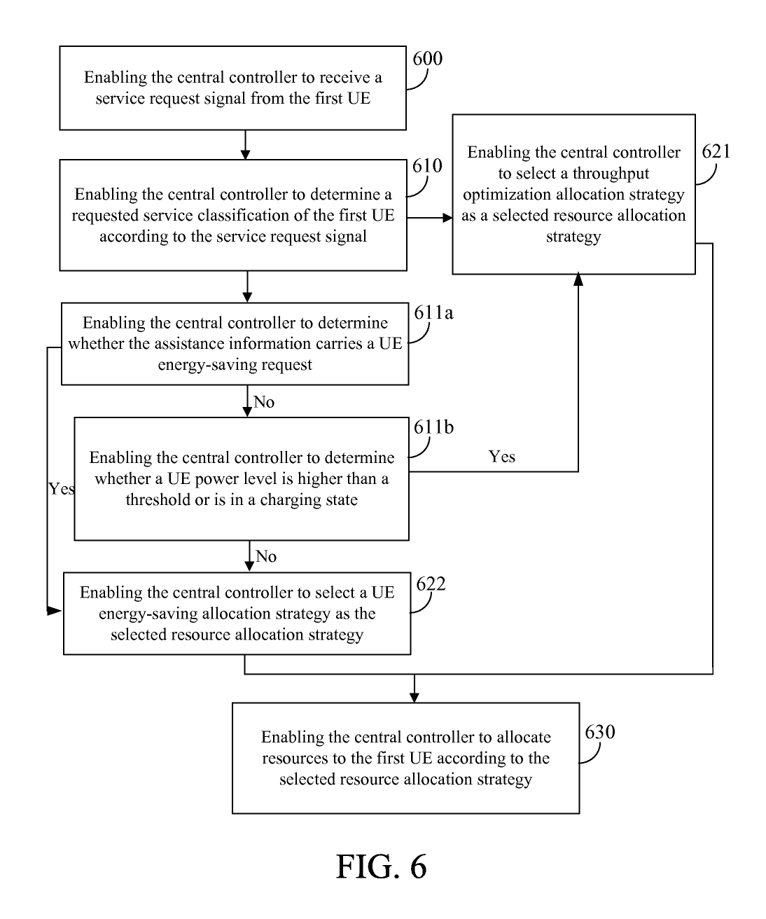

A seventh embodiment of the present invention is shown in FIG. 6, which depicts a resource allocation method of the present invention in case of an uplink application service request. The resource allocation method is used in a central controller in a cellular network. The cellular network comprises the central controller and a first UE. It should be appreciated that, the cellular network, the central controller and the first UE set forth in this embodiment have the same functions as the cellular network 1, the central controller 10 and the first UE UE1 in the first embodiment and the second embodiment.

Firstly in the resource allocation method, a step 600 is executed to enable the central controller to receive a service request signal from the first UE. The service request signal is an uplink application service request, and a resource allocation strategy set of this embodiment comprises a UE energy-saving allocation strategy and a throughput optimization allocation strategy.

Next, a step 610 is executed to enable the central controller to determine a requested service classification of the first UE according to the service request signal. Specifically in this embodiment, the requested service classification of the first UE is determined according to the service request signal belonging to the uplink application service request. If the requested service classification is a non-periodic data transmission classification, a step 621 is executed to enable the central controller to select the throughput optimization allocation strategy as a selected resource allocation strategy according to the non-periodic data transmission classification. If the requested service classification is a periodic data transmission classification, a step 622 is executed to enable the central controller to select the UE energy-saving allocation strategy as the selected resource allocation strategy according to the periodic data transmission classification.

After the step 621 or the step 622, a step 630 is further executed to enable the central controller to allocate resources to the first UE according to the selected resource allocation strategy so that the central controller and the first UE transmit data corresponding to the service request signal via the resources.

It should be appreciated that, in addition to the steps 610, 621, 622 and 630, the resource allocation method of this embodiment may optionally comprise steps 611a and 611b for making further determinations. In the case where the steps 611a and 611b are optionally comprised, the step 600 of the resource allocation method further comprises the following step of: enabling the central controller to receive an assistance information (e.g., a piece of UE assistance information in Release 12 of the 3GGP standard) from the first UE. The steps 611a and 611b are executed between the step 610 and the step 622, and will be described respectively as follows.

As shown in FIG. 6, if it is determined that the requested service classification is the periodic data transmission classification in the step 610, then the step 611a is executed to enable the central controller to determine whether the assistance information carries a UE energy-saving request therein; and if the determination result is “yes”, the step 622 is executed to enable the central controller to select the UE energy-saving allocation strategy as the selected resource allocation strategy according to the fact that the requested service classification belongs to the periodic data transmission classification and the UE energy-saving request.

If the determination result of the step 611a is “no”, then the step 622 can be directly executed in the resource allocation method; or, if the assistance information further carries a piece of UE power level information of the first UE therein, the step 611b is executed to enable the central controller to determine whether a UE power level of the first UE is higher than a threshold or whether the first UE is in a charging state. If the determination result of the step 611b is “yes”, the step 621 is executed; and if the determination result is “no”, the step 622 is executed. It should be appreciated that, one or both of the steps 611a and 611b may be executed, or the steps 611a and 611b may both be omitted; and because how this operates is well known to those skilled in the art, this will not be further described herein.

In addition to the aforesaid steps, the resource allocation method of the seventh embodiment can also execute all the operations and functions of the central controller in case of the uplink application service request in the first embodiment and the second embodiment. Because how the resource allocation method of the seventh embodiment executes these operations and functions can be readily known by those of ordinary skill in the art based on the first embodiment and the second embodiment, it will not be further described herein.

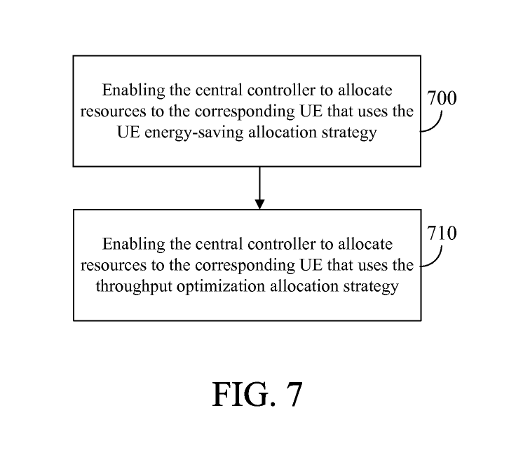

An eighth embodiment of the present invention is shown in FIG. 7, which depicts a resource allocation method of the present invention in case of an uplink application service request. The resource allocation method and involved elements (i.e., a cellular network, a central controller and a first UE) of the present invention are the same as the resource allocation method and the involved elements of the seventh embodiment except that the cellular network of this embodiment further comprises a second UE and a third UE. As can be known from the plurality of UEs arranged in this embodiment, this embodiment mainly focuses on how to allocate resources to the plurality of UEs using different resource allocation strategies. It should be appreciated that, the number of the UEs in this embodiment is only for purpose of illustration rather than to limit the present invention.

Herein, the step 630 of the seventh embodiment shown in FIG. 6 may be construed as a step for a single UE. However, the central controller usually allocates resources to a plurality of UEs, and in this embodiment, allocates resources to the first UE, the second UE and the third UE according to a second execution sequence.

In this embodiment, because the service request signal of this embodiment is an “uplink application service request” and energy-saving for the central controller is not considered, the resource allocation strategy set of this embodiment only comprises the UE energy-saving allocation strategy and the throughput optimization allocation strategy.

Therefore, assume that the central controller executes the aforesaid steps 600˜622 for the first UE to the third UE respectively, and selects the UE energy-saving allocation strategy as the selected resource allocation strategy for the first UE, selects the throughput optimization allocation strategy as the selected resource allocation strategy for the second UE, and selects the UE energy-saving allocation strategy as the selected resource allocation strategy for the third UE. In this embodiment, the central controller allocates resources directly according to the second execution sequence. Generally speaking, the UE energy-saving allocation strategy should be executed with a priority over the throughput optimization allocation strategy because the UE energy-saving allocation strategy is more important. Therefore, the second execution sequence is as follows: the UE energy-saving allocation strategy is executed with a priority over the throughput optimization allocation strategy.

According to the second execution sequence, a step 700 is executed to enable the central controller to allocate resources to the corresponding UE(s) that uses the UE energy-saving allocation strategy. Specifically in this embodiment, the central controller allocates resources firstly to the first UE and the third UE. Afterwards, a step 710 is executed to enable the central controller to allocate resources to the second UE. As can be known from the above descriptions, the second execution sequence is represented by the contents of the steps 700 and 710. It should be appreciated that, the content of the second execution sequence is provided only for purpose of illustration rather than to limit the present invention, and the second execution sequence may also be adjusted depending on the actual need.

In addition to the aforesaid steps, the resource allocation method of the eighth embodiment can also execute all the operations and functions of the central controller in case of the uplink application service request in the first embodiment to the third embodiment. Because how the resource allocation method of the eighth embodiment executes these operations and functions can be readily known by those of ordinary skill in the art based on the first embodiment to third embodiment, it will not be further described herein.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A central controller for use in a cellular network, the cellular network comprising a first user equipment (UE) and the central controller, the central controller comprising:
a transceiver, being configured to receive a service request signal from the first UE; and
a processor electrically connected to the transceiver, being configured to execute a resource allocation procedure which comprises the following steps of:
determining a requested service classification of the first UE according to the service request signal by the processor;
selecting a selected resource allocation strategy from a resource allocation strategy set according to the requested service classification by the processor; and
allocating resources to the first UE according to the selected resource allocation strategy by the processor so that the central controller and the first UE transmit data corresponding to the service request signal via the resources.

2. A resource allocation method for a central controller in a cellular network, the cellular network comprising a first UE and the central controller, the resource allocation method comprising:
the central controller receiving a service request signal from the first UE;
the central controller determining a requested service classification of the first UE according to the service request signal;
the central controller selecting a selected resource allocation strategy from a resource allocation strategy set according to the requested service classification; and
the central controller allocating resources to the first UE according to the selected resource allocation strategy so that the central controller and the first UE transmit data corresponding to the service request signal via the resources.

3. The resource allocation method as claimed in claim 2, wherein the service request signal is a downlink application service request, the requested service classification is a periodic data transmission classification, and the selected resource allocation strategy is a UE energy-saving allocation strategy.

4. The resource allocation method as claimed in claim 3, wherein the central controller further receives a piece of assistance information from the first UE, the assistance information comprises a UE energy-saving request, and the step of enabling the central controller to select the selected resource allocation strategy from a resource allocation strategy set according to the requested service classification comprises:
the central controller selecting the UE energy-saving allocation strategy from the resource allocation strategy set as the selected resource allocation strategy according to the requested service classification and the UE energy-saving request.

5. The resource allocation method as claimed in claim 3, further comprising:
the central controller determining that the first UE supports a system discontinuous reception (DRX) mechanism;
wherein the step of the central controller to selecting the selected resource allocation strategy from the resource allocation strategy set according to the requested service classification includes the following step:
the central controller selecting the UE energy-saving allocation strategy from the resource allocation strategy set as the selected resource allocation strategy according to the requested service classification and a result that the first UE supports the system DRX mechanism.

6. The resource allocation method as claimed in claim 2, further comprising:
the central controller determining that the first UE does not support a system DRX mechanism;
wherein the step of the central controller selecting the selected resource allocation strategy from the resource allocation strategy set according to the requested service classification is the following step:
the central controller selecting the central controller energy-saving allocation strategy from the resource allocation strategy set as the selected resource allocation strategy according to the requested service classification and a result that the first UE does not support the system DRX mechanism.

7. The resource allocation method as claimed in claim 3, wherein the assistance information further comprises a piece of UE power level information, the resource allocation method further comprising:
the central controller determining that a UE power level in the UE power level information is lower than a threshold;
wherein the step of the central controller selecting the selected resource allocation strategy from the resource allocation strategy set according to the requested service classification includes the following step:
the central controller selecting the UE energy-saving allocation strategy from the resource allocation strategy set as the selected resource allocation strategy according to the requested service classification and a result that the UE power level is lower than the threshold.

8. The resource allocation method as claimed in claim 2, wherein the service request signal is a downlink application service request, the requested service classification is a periodic data transmission classification, the central controller further receives a piece of assistance information from the first UE, and the assistance information comprises a piece of UE power level information, the resource allocation method further comprising:
the central controller determining that a UE power level in the UE power level information is higher than a threshold;
wherein the step of the central controller selecting the selected resource allocation strategy from the resource allocation strategy set according to the requested service classification includes the following step:
the central controller selecting a central controller energy-saving allocation strategy from the resource allocation strategy set as the selected resource allocation strategy according to the requested service classification and a result that the UE power level is higher than the threshold.

9. The resource allocation method as claimed in claim 2, wherein the service request signal is a downlink application service request, and the requested service classification is a periodic data transmission classification, the resource allocation method further comprising:
the central controller determining that the central controller additionally provides the first UE with a service belonging to a non-periodic data transmission classification so that the central controller selects a central controller energy-saving allocation strategy from the resource allocation strategy set as the selected resource allocation strategy.

10. The resource allocation method as claimed in claim 2, wherein the service request signal is a downlink application service request, the requested service classification is a non-periodic data transmission classification, and then the selected resource allocation strategy is a throughput optimization allocation strategy.

11. The resource allocation method as claimed in claim 2, wherein the cellular network further comprises at least one second UE, and the service request signal is a downlink application service request, the resource allocation method further comprising the following step when the selected resource allocation strategy is a UE energy-saving allocation strategy:
the central controller determining that an expected total amount of resources used by one of the at least one second UE and the first UE is larger than a critical value, and then update the selected resource allocation strategy from the UE energy-saving allocation strategy into a central controller energy-saving allocation strategy;
wherein the central controller allocates resources to the first UE and the at least one second UE according to an execution sequence.

12. The resource allocation method as claimed in claim 2, wherein the service request signal is an uplink application service request and the requested service classification is a periodic data transmission classification, and then the selected resource allocation strategy is a UE energy-saving allocation strategy.

13. The resource allocation method as claimed in claim 12, wherein the transceiver further receives a piece of assistance information from the first UE, the assistance information comprises a UE energy-saving request, and the step of enabling the central controller to select the selected resource allocation strategy from the resource allocation strategy set according to the requested service classification including the following step:
the central controller selecting the UE energy-saving allocation strategy from the resource allocation strategy set as the selected resource allocation strategy according to the requested service classification and the UE energy-saving request.

14. The resource allocation method as claimed in claim 12, wherein the central controller further receives a piece of assistance information from the first UE, the resource allocation method further comprising:
the central controller determining that a UE power level of the first UE carried in the assistance information is lower than a threshold;
wherein the step of the central controller selecting the selected resource allocation strategy from the resource allocation strategy set according to the requested service classification includes the following step:
the central controller selecting the UE energy-saving allocation strategy from the resource allocation strategy set as the selected resource allocation strategy according to the requested service classification and a result that the UE power level is lower than the threshold.

15. The resource allocation method as claimed in claim 2, wherein the service request signal is an uplink application service request, the requested service classification is a periodic data transmission classification, and the central controller further receives a piece of assistance information from the first UE, the resource allocation method further comprising:
the central controller determining that a UE power level in the assistance information is higher than a threshold;
wherein the step of the central controller selecting the selected resource allocation strategy from the resource allocation strategy set according to the requested service classification is the following step:
the central controller selecting a throughput optimization allocation strategy from the resource allocation strategy set as the selected resource allocation strategy according to the requested service classification and a result that the UE power level is higher than the threshold.

16. The resource allocation method as claimed in claim 2, wherein the service request signal is an uplink application service request and the requested service classification is a non-periodic data transmission classification, and then the selected resource allocation strategy is a throughput optimization allocation strategy.
